(19) United States
(12) Patent Application Publication
(10) Pub. No.: US 2004/0193483 A1
(43) Pub. Date: Sep. 30, 2004

(54) Methods and systems for advertising products

(76) Inventor: Alan Wolan, New York, NY (US)

Correspondence Address: Mark P. Stone, 25 Third Street 4th Floor, Stamford, CT, 06905, US

(21) Appl. No.: 10/395,981

(22) Filed: Mar. 25, 2003

(51) Int. Cl. G06F 17/60

(52) U.S. Cl. 705/14

(57) ABSTRACT

A method and system for advertising one or more predetermined products or services employs the production of a series of stories broadcast on a television network, shown in movie theaters, or employed in Internet advertising. The stories focus on a particular fictional family, both immediate and extended, and other persons associated therewith, following the characters as their lives evolve. One or more products or services to be advertised are included in each story, and are either expresssly or implicitly endorsed by one or more of the characters in the continuing story line of the television series.

### BACKGROUND OF THE INVENTION

The present invention is directed to improvements to commercials, and in particular commercials appearing in television broadcasts. Typically, television commercials are separate from the television programming broadcast by a network. As a general rule, television commercials have no relation to the story line of shows being broadcast on the network, and, in fact, interrupt the entertainment programming. Such interruptions are generally treated as an annoyance by the viewing public, and in many instances provide viewers who have no interest in seeing the commercial with an opportunity to leave the area of their television sets until the regular programming resumes.

It is an object of the present invention to replace the known commercial with a series of stories in which the product to be advertised appears, but is not central to the main theme of the stories, to generate interest by the viewing public of the stories as a source of entertainment and not as an advertisement for one or more products.

Other objects and advantages of the methods and systems of the present invention will become apparent from the following discussion.

### SUMMARY OF THE INVENTION

The present invention provides new methods for advertising, promoting and endorsing one or more specific products and brands, in video format, primarily on television broadcast, cable and satellite. However, the method and systems in accordance with the present invention may also be employed in other media, as for example, video ads run in movie theaters, video ads on the internet and any other medium where video ads can run.

The present invention is a new format of video advertisement. The format consists of creating a fictional family with a mother, father and two or more children. A “series” of separate “spots” (advertising jargon for “commercials”) will be created which portrays the characters going about their daily lives. Other family members such as grandparents, aunts and uncles as well as friends will be introduced as the series progresses. The family, its members and their travails becomes the focal point of the series. Product endorsements are sometimes included in the storyline but are not central to the viewers experience of the series. Each spot aired will consist of a different short story whereby the characters are engaged in some kind of activity or discussion which is entertaining, interesting and fun. Product endorsements will not be a part of every spot but will be a part of many of the spots.

The concept will be introduced with spots which contain no advertising and are designed purely for consumers to get to know the family and its members. The goal is for consumers to experience an affinity with the characters. As the series progresses, products and particular brands will take on a more significant role as characters go shopping, make brand decisions, talk to each other about products and why they use particular brands.

The series will not be permanently affiliated with any particular brands or classification of products. Any brand will be considered for inclusion in the series and products will be included which cut across all categories. For example, cars, detergents, clothing, electronics, candy, toothpaste, pharmaceuticals, and any other category of product will be featured.

The series is designed to run with the same characters over many years. The characters will grow older along with consumers and their affinity and trust for the characters will grow as time passes. Consumers will experience the characters as friends and even as their own family members.

What makes this concept new and different from traditional video advertising is:

a). the focal point of this advertising format is not the brand, but rather the storyline of the fictional family. Traditional video ads have the brand as the focal point and the storyline is used solely to support the brand;

b). some of the commercials will contain no brand promotion at all. Traditional video ads always include some mention of the product being promoted;

c). this advertising fomrat allows for the promotion of multiple brands in the same spot, from many different product categories. Traditional video ads support only one product at a time;

d). this advertising format is designed to run with the same characters over many years. The goal is to show the aging of the characters and to create the feeling that they are getting older along with the viewers. Traditional video ads typically change the characters within a short period of time, and when they use the same character over an extended period, they attempt to hide the fact that the character has aged;

e). this advertising format will portray negative aspects of life, such as sickness or even death of a character, much as do television series. This will create a heightened sense of reality about the series and its characters. Traditional video ads show a more rosey view of life and avoid all negative aspects of life.

Revenues from the business will be generated from four (4) sources:

1). advertising: brand advertisers will pay a fee to have their brand featured in the series, (e.g., characters will discuss which type of detergent they prefer);

2). product placement: companies will pay a fee to have their brands and logos appear in the series, (e.g., one of the characters will wear a brand name cap);

3). character licensing: the characters in the series will appear in other series, write books, record albums and licensing fees will be paid to the parent company; and

4). concept licensing: the concept will be licensed to ad agencies in non-U.S. countries and licensing fees will be paid to the U.S. parent company.

One or more products or services to be advertised or promoted are included in separate stories which are broadcast on home television programming or in movie theaters sequentially over an extended period of time. Each story is centered around a fictional family, its extended family and friends and other acquaintances and associates of the fictional family. Additionally characters are added to the story line, or existing characters deleted from the story line, during different sequential broadcasts of the continuing episodes. For example, a different episode of the story can be broadcast once every week in a designated time slot on a particular network. Similarly, if the episodes are to be shown in movie theaters, they can be shown with each new movie being run by the theater. Preferably, each episode is relatively short in time duration (e.g., five minutes or less).

The episodes include one or more products or services to be advertised or promoted, either expressly or implicitly. Implicit promotion of a product or service occurs by virtue of its being shown in the episode, without targeting any specific attention to the product or service. Express endorsement of a product or service occurs when one or more of the characters in an episode expressly refers to the product or service in a favorable manner. As television or movie viewers follow the different sequential episodes, they will become familiar with the characters and, to some extent, will identify with them. As the series progresses, viewers develop an affinity towards one or more of the characters, increasing the viewers confidence in the characters and their ability to make decisions and judgments. This increased confidence and affinity in the characters becomes associated with the products and services viewers now identify and associate with the characters.

### DESCRIPTION OF THE BEST MODE FOR CARRYING OUT THE INVENTION

The present invention is directed to improved methods and systems for promoting and advertising products on broadcast medias, commonly known as commercials. Although the invention is disclosed herein in connection with a broadcast television commercial over a commercial television network, the methods and systems of the present invention are equally applicable to cable and satellite television networks and broadcasting, to motion pictures exhibited in movie theaters, and to Internet and online advertising. Moreover, although the following discussion is directed to products to be advertised, the methods and systems disclosed herein are equally applicable to services to be advertised. Therefore, the term “products” as used herein is intended to cover both “products” and “services”.

The format of the new commercial creates a fictional family including a mother, father and one or more children. A series of separate short stories is created to portray the characters in their daily routines. As the stories progress, additional family members, such as grandparents, aunts and uncles, as well as friends, neighbors and acquaintances, will be introduced into the theme. Each episode of the series is a short story, preferably less than five minutes in duration, having a specific plot or theme. The family, and other individuals introduced into the stories, become the focal point of the series. The sequential series of stories follows the characters as they evolve over time in the course of their individual lives.

Preferably, when the stories are to be broadcast on television programming, a different story will be shown at designated time intervals (e.g., weekly), preferably at the same time slot so that viewers developing an interest in the story will know when the episodes are to be broadcast. The series can be simultaneously broadcast by different television networks. Preferably, the time intervals between the broadcast of different episodes will be selected to avoid saturation of the audience, thereby creating interest by the viewers in seeing the next upcoming episode.

When episodes are shown in movie theaters, preferably a new episode will be shown with each new movie being shown in the theater. Therefore, new episodes will, as a general rule, be shown on a frequency of about every 1-2 weeks in each theater.

Each of the different episodes highlights the characters, their activities, and the plot or theme of the episode. The specific brand name products (or services) to be advertised and endorsed are secondary in importance to the characters and their activities. In each episode, one or more of the preselected products to be advertised are endorsed, either implicitly or expressly, by one or more of the characters. An express endorsement occurs when one or more of the characters identifies one or more of the preselected products appearing in an episode and makes a favorable statement directed towards the product. An implicit endorsement of a product occurs merely by conspicuously displaying the product in an episode so that the viewing audience implicitly associates the displayed product with the characters.

As the viewing audience follows the evolution of the characters as they conduct their daily activities, the viewers develop an affinity for the characters, and their judgments and decisions as reflected in the different episodes and story lines of the series. Preferably, the characters are portrayed as likeable and trustworthy, thereby implicitly creating a favorable association between the characters and the products that they expressly endorse, or the products shown appearing in their day to day routine.

Initially, the beginning episodes of the series include stories which are substantially free of any advertising or promotion of any products to enable the viewing audience to become acquainted with, and develop an affinity for, the characters. As the series progresses, products and particular brands to be promoted and advertised take on a more significant role so as to associate the products with the goodwill created in the characters. However, the central theme of each episode and the ongoing series emphasizes the characters and their activities more prominently than the products which they endorse. As the series progresses, the characters can be followed as they go on shopping trips, make product decisions, and discuss different products and brands with each other. Each successive episode of the series enables viewers to strengthen their affinity to the characters, thereby enhancing the favorable association between the characters and the products which they use or endorse. The products displayed, used, discussed, and endorsed in the ongoing series includes, for example, cars, detergents, clothing, electronics, candy, toothpaste, pharmaceuticals, and foods and beverages.

The series is intended to run in sequential episodes over an extended period of time, preferably years, and include both characters which are common to all episodes and other characters which are added as the series progresses. The characters common to the series will grow older together with the viewing audience which forms the consuming public, thereby strengthening the affinity and trust between the characters and the consumers as time passes. Preferably, the viewing audience will treat the characters of the series on a level comparable to friends and family members as a result of the continuous and ongoing involvement of the viewers in the lives of the fictional characters.

Revenues can be derived from the aforementioned concept in several different ways. Brand advertisers will pay a fee to have their brand featured in the series, as for example explicit reference to the brand name products in a favorable context during discussions between the characters in the different sequential episodes. Companies will pay a fee to have their brands and logos appear in the series as a result of product placement in which one or more characters wear or use a branded product, or a recognizable brand appears without mention in the episode. The series can generate other series, books, record albums, and branded merchandise featuring the characters appearing in the series. The basic advertising concept discussed herein can be licensed to advertising agencies.

Other objects and advantages of the methods and systems disclosed herein will become apparent to those skilled in the art. Accordingly, the discussion of the best modes of the invention disclosed herein is intended to be illustrative only, and not restrictive of the scope of the invention, that scope being defined by the following claims and all equivalents thereto.

1. A method of advertising one or more preselected products or services, said method including the steps of:
developing a story including one or more characters,
introducing said one or more preselected products or services into said story, and
broadcasting said story including said one or more characters and said one or more preselected products or services to be advertised.

2. The method as claimed in claim 1 further including the step of:
dividing said story into a plurality of sequences.

3. The method as claimed in claim 2 further including the step of:
broadcasting said plurality of sequences at different times.

4. The method as claimed in claim 3, further including the step of:
broadcasting said plurality of sequences at predetermined time intervals.

5. The method as claimed in claim 3, further including the step of:
introducing at least one additional character in each successive sequence of said story.

6. The method as claimed in claim 3, further including the step of:
introducing at least one additional preselected product or service to be advertised in each successive sequence of said story.

7. The method as claimed in claim 2, further including the step of broadcasting said plurality of sequences on a television network.

8. The method as claimed in claim 2, further including the step of:
broadcasting said plurality of sequences on a cable television network.

9. The method as claimed in claim 2, further including the step of:
broadcasting said plurality of sequences on a satellite television network.

10. The method as claimed in claim 2, further including the step of:
broadcasting said plurality of sequences in a motion picture theater.

11. The method as claimed in claim 2, further including the step of:
broadcasting said plurality of sequences on the Internet.

12. The method as claimed in claim 2, further including the step of endorsing at least one of said preselected products or services by at least one of said characters in at least one of said plurality of sequences of said story.

13. The method as claimed in claim 2, further including the step of:
displaying at least one of said preselected products or services in at least one of said plurality of sequences in said story.

14. The method as claimed in claim 12, further including the step of:
displaying at least one of said preselected products or services in a plurality of said sequences of said story.

15. A method of advertising one or more preselected products or services, said method including the steps of:
developing a story including one or more characters,
introducing said one or more preselected products or services into said story,
dividing said story into a plurality of sequences, and
broadcasting successive sequences of said story on a television network on the same day of the week and at the same time of the day.

16. The method as claimed in claim 15, further including the step of displaying the same preselected product or service in each of a plurality of successive sequences of said story.

17. The method as claimed in claim 15, further including the step of:
endorsing the same preselected product or service by at least one character in a plurality of successive sequences of said story.

18. The method as claimed in claim 15, further including the step of:
endorsing at least one said preselected product or service by at least two characters in at least one sequence of said story.

19. A method of advertising one or more preselected products or services, said method including the steps of:
developing a story including one or more characters,
introducing said one or more of said preselected products or services into said story,
dividing said story into a plurality of sequences,
broadcasting said plurality of sequences, and
endorsing a plurality of said preselected products or services by at least one character in a plurality of sequences of said story.

20. The method as claimed in claim 19, further including the step of:
endorsing a plurality of said preselected products or services by a plurality of said characters in at least one sequence of said story.
